(19) United States
(12) Patent Application Publication
(10) Pub. No.: US 2008/0040157 A1
(43) Pub. Date: Feb. 14, 2008

(54) Methods and systems for storing and providing information related to companion animals

(76) Inventor: Brent Saunders, Warren, NJ (US)

Correspondence Address: PATENT DOCKET ANDMINSTRATOR;LOWENSTEIN SANDLER PC, 65 LIVINGSTON AVENUE, ROSELAND, NJ, 07068, US

(21) Appl. No.: 11/504,365

(22) Filed: Aug. 14, 2006

(51) Int. Cl. G06Q 50/00

(52) U.S. Cl. 705/3

(57) ABSTRACT

Systems and methods for storing and providing information related to companion animals. Electronic records for companion animals are stored in a remote central database of a companion animal service central storage module. The electronic records can be associated with an identifier on an encoded electronically readable tag implanted in a companion animal. The central database can electronically receive from a companion animal health care provider data related to the health of the animal. A set of alphanumeric codes can be assigned to one or more of the health data and stored in an electronic record of the database. Furthermore, remote access to a portion of the electronic record can be provided to the companion animal owner.

### FIELD OF THE INVENTION

Embodiments of the invention relate to methods and a systems for storing and providing information related to companion animals, and, more particularly, to methods and systems for remotely storing and providing identification information and health information of companion animals.

### BACKGROUND OF THE INVENTION

Companion animals, or pets, are often very important to their owners, and are often the source of concern regarding both the safety and health of the animals. One of the biggest fears for an owner is his companion animal being lost. To help identify lost animals, various methods have been used, including collar tags imprinted with information related to the animal and/or the owner. Tags, however, can easily be removed or separated from the animal. Tattooing companion animals with a number, such as the companion animal owner's social security number, is another method of identifying companion animals, especially dogs.

Another means available to identify a companion animal is a system that includes the implanting of a microchip, transponder (electronic tag) or other similar identification device into the animal. When a lost animal is found, the animal can be scanned using, for example, a radio frequency identification (RFID) reader, which reads an identification number on the tag. The implanted tag thus provides a permanent, unique identifier that remains in place, so the when the companion animal is found, it can easily be identified and the owner can be notified. See, e.g., U.S. Pat. No. 5,211,129, the contents of which are hereby incorporated by reference herein.

If the found companion animal is injured or requires medical treatment, the companion animal may be taken to a local emergency care center or animal hospital. The emergency care center, however, will typically not have access to medical records of the animal and therefore may not be able to provide the best medical care required for the animal. A similar situation may arise when an owner is traveling away from home, for example, on vacation, with a companion animal. If the animal becomes ill or otherwise requires medical assistance, the owner may bring his/her animal to the nearest vet or animal shelter. The workers at these locations, however, will not have access to the medical records of the animal, and thus, may not be able to provide the best medical treatment to the animal.

Thus, there is a need to provide an easy and automated system and method for remotely accessing medical providers, companion animal owners and others for information pertaining to medical conditions, treatments and procedures such as vaccinations, diseases and other health records of the companion animal.

### SUMMARY OF THE INVENTION

Embodiments of the invention solve these and other needs by providing systems and methods for storing and providing information related to companion animals. Electronic records for companion animals are stored in a remote central database of a companion animal service provider. The electronic records can be associated with an identifier that relates to an encoded electronically readable tag implanted in a companion animal. The central database can electronically receive from a companion animal health care provider data related to the identification and the health of the animal. A set of alphanumeric codes can be assigned to one or more of the health data and stored in an electronic record of the database. Furthermore, a secure remote access to a portion of the electronic record can be provided to the companion animal owner, a companion animal health service provider or another party authorized to receive identity of the companion animal and/or authorized to provide health treatment to the animal.

### BRIEF DESCRIPTION OF THE DRAWINGS

FIGS. 1 and 1A are block diagrams showing a system for storing and providing information related to a companion animal, in accordance with embodiments of the invention;

FIG. 2 is a flow diagram illustrating a method for storing and providing information related to a companion animal, in accordance with embodiments of the invention; and

FIG. 3 is a front view of a companion animal identification card providing codes related to health records of a companion animal, in accordance with embodiments of the invention.

### DETAILED DESCRIPTION OF THE INVENTION

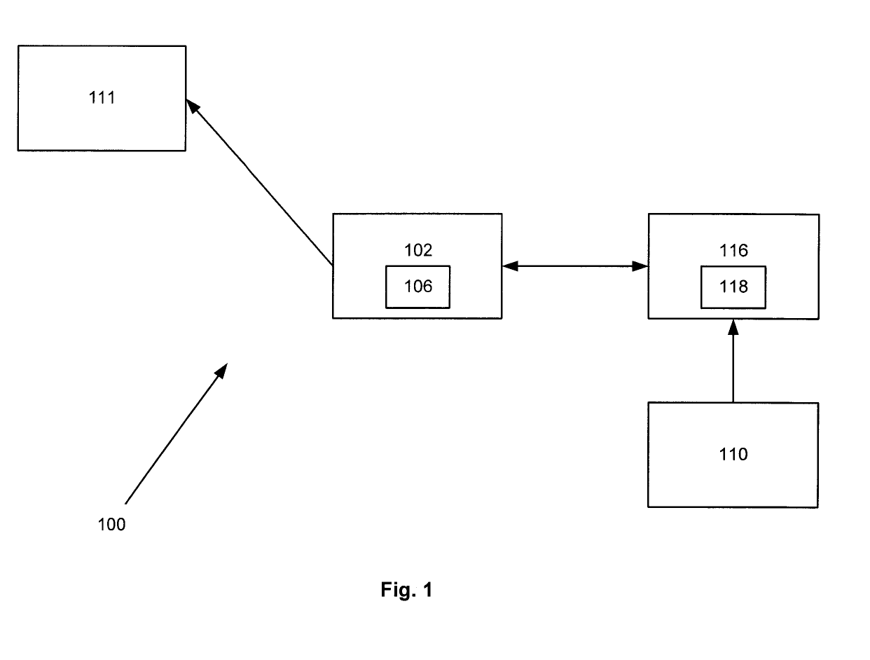

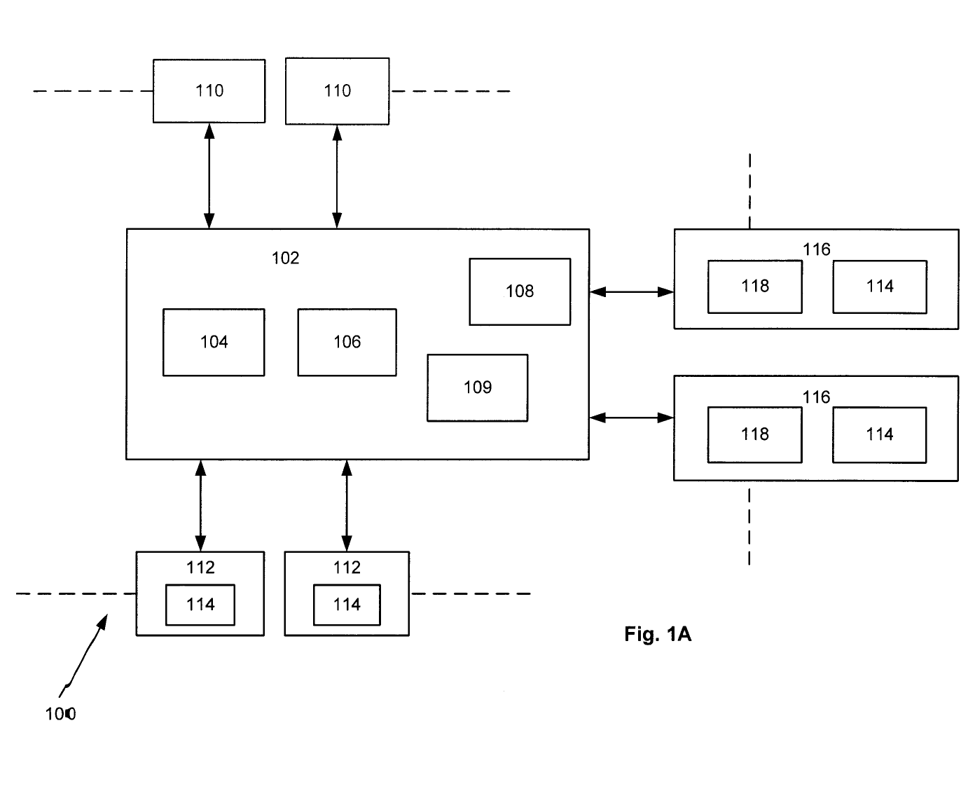

With reference to FIG. 1, there is shown a system in accordance with embodiments of the invention. By way of the system, an owner 110 can bring his companion animal to an animal health care provider center 116. Health care provider center 116 can be, for example, a vet's office, animal shelter, or other facility wherein a companion animal can receive health care assistance. A microchip, including a unique id, can be implanted into the companion animal at the companion animal health care provider center 116, and information related to the unique id, i.e. the identity, as well as information related to the health of the companion animal, can be stored in a companion animal database 118 in a server or other computing device (not shown) of the companion animal health care provider center 116. The information related to the unique id, as well as information related to the health and the identity of the companion animal can be periodically uploaded and stored at companion animal service center 102 in central database 106. Portions of the identification information and health records of the companion animal can then be remotely accessed by the owner 110, or another person or a service with authorization 111, who finds a lost companion animal.

Referring to FIG. 1A, system 100 is shown in greater detail. Companion animal service center 102 can include one or more processors 104, communicatively coupled to a global computer implemented network, such as the Internet, or any other type of network, such as an Intranet, Virtual Private Network (VPN), local area network (LAN), wide area network (WAN), etc., and a central database 106. Companion animal service center 102 can also include call center 108, which is described in further detail below. An animal health care provider center 112 can include a microprocessor controlled programmable device 114 such as a scanner for scanning/reading encoded electronically readable unique identifiers implanted in companion animals. Companion animal health care provider center 116 comprises a companion animal database 118 for storing information about the companion animal that are treated or inspected by a health care provider in the companion animal health care provider's office in the center. The center also comprises of the microprocessor-controlled programmable device 114 which may preferably be user programmable. Microprocessor-controlled device 114 can be a personal computer, handheld device, or other microprocessor-based device.

In certain embodiments, the information in the companion animal database 118 can include data related to the companion animal such as a companion animal profile, companion animal health-related data, a companion animal owner profile and a companion animal health care provider profile.

The companion animal profile can include one or more of a companion animal's picture or image, name, gender, age, weight, breed, color, birth date, license date and any additional general information associated with the companion animal. The companion animal profile may also include a unique alphanumeric identification code if, for example, the companion animal is implanted with an encoded, electronically-readable or other similar identifier, such as an RFID tag.

The companion animal health-related data can include medical records, including vaccination history and rabies history, history of health treatment, prescription medicine history, allergies, spaying/neutering and drug dosing, and any other additional information related to the health of the companion animal. Related date information can also be included.

The companion animal owner profile can include a companion animal owner's name and contact information.

The companion animal health care provider profile can include, for example, a companion animal health care provider name, clinic name and contact information.

The microprocessor controlled device 114, such as, for example, an RFID reader, can be used to scan the encoded, electronically-readable tag (or other similar identifier), such as an RFID tag, which may be implanted in the companion animal by the companion animal health care provider at the center 116. The tag can include a microchip, and can be configured as a passive electronic device that emits a radio frequency only when activated by the scanner. See e.g., U.S. Pat. No. 5,952,935, the contents of which are hereby incorporated by reference herein. Each tag can be designed with the express purpose of storing and transmitting a unique alphanumeric identifier (ID). Thus, each of these tags has a unique identifier (ID) assigned to differentiate one companion animal from another. The IDs scanned by the microprocessor controlled device 114 may be manually inputted into the companion animal profile stored in the companion animal database 118 of the companion animal health care provider center 116. The IDs can also be automatically inserted into the companion animal database 118 by electronically linking the microprocessor controlled device 114 to the database via a server (not shown) at the health care provider center 116. The ID represents a companion animal's identification, which can be used by the companion animal service center 102 to correlate with the information related to the companion animal as is described below.

Alternatively, the unique identifier may be associated with a biometric code which uniquely identifies the animal. The biometric code may correspond to the companion animal through biometric or physical characteristics such as those related to a retina, iris, fingerprint, hand geometry, facial pattern, voice or other characteristic of the animal.

The central database 106 of the companion animal service center 102 can include electronic records of the companion animals, which are associated with the unique IDs of the tags. A server 109 at the companion animal service center 102 receives electronically, over the Internet, from the companion database 118 of the health care center 116, the data related to the companion animal. As discussed above, this data can include a companion animal profile, companion animal health related data, companion animal owner profile and companion animal health care provider profile. The companion animal profile and the companion animal health care provider profile can be loaded on to the database 106 associated with the electronic record established for each companion animal listed in the database. The companion animal health data can be assigned alphanumeric codes by a processor 104 in the server, in accordance with pre-defined conventions. For example, an indication of prior treatment for fleas could be assigned a code of “01.” Further, these codes together with their associated health data, along with the companion animal profile, companion animal owner profile and companion animal health care provider profile can be stored in the database 106. The alphanumeric codes can be used as a shortcut or abbreviated form of the companion animal health records for transmission to a remote location to facilitate treatment of a companion animal. This data is stored in the database with its corresponding electronic record of the unique ID established for each companion animal.

In some embodiments, if there is no electronic record found in the database 104 matching with one or more of a plurality of companion animal related data, a record may be established for this data without the unique ID. This allows one or more companion animals to be associated to the companion animal related data, even if the animals have not been implanted with an identifier. Subsequently, if one or more companion animals are implanted with an identifier in the companion animal health care provider's office, they can be scanned by the microprocessor controlled device 114 and their unique ID(s) can be entered into the companion animal database 118.

Moreover, the data related to the companion animal in the companion animal database 118 can be modified and updated periodically with not only the unique ID, but also other information related to the companion animal profile, health data, companion animal owner profile and the companion animal health care provider profile. Thus, in some embodiments, the companion animal service center 102 receives this updated data on regular basis, including, optionally, by an automated process that may run at regular intervals, which is then stored in the central database 106. For example, if the updated data has a unique number which was not previously assigned, it can subsequently be matched with a corresponding electronic record in the database 106. In another example, if the updated data includes additions to or modifications of the health data, it can again be reviewed by the processor to assign an alphanumeric code and further stored in its corresponding electronic record in the database 106. The service center 102 further provides to the companion animal owners 110 and to the companion animal health care provider 116 access to the data related to the companion animal in the central database 106.

In embodiments of the invention, the companion animal health care provider center 116 includes an entry portal (not shown). The portal can includes a microprocessor controllable device 114 which automatically scans the companion animal encoded computer readable identifier (microchip) when the companion animal enters the center 116. Thus, the portal allows for the automatic scanning of the identifier when the companion animal enters the facility/center 116.

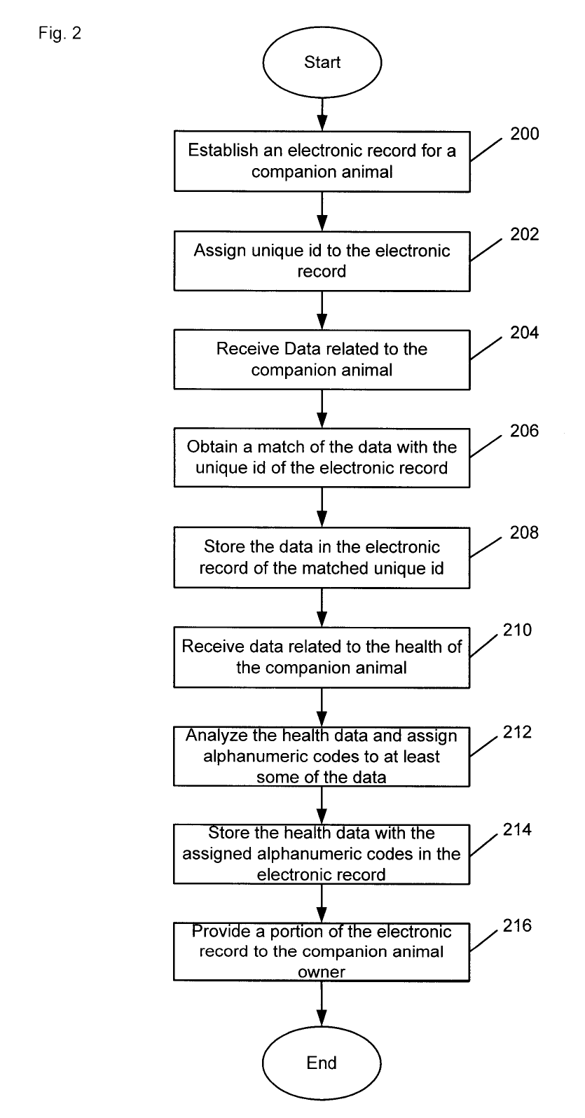

With reference to FIG. 2, a method for storing and providing information related to a companion animal is shown. At step 200 at least one or more electronic records are established for the companion animal, which are stored in the database 104. Then at least one or more unique IDs are assigned to the electronic records at step 202. As mentioned above, these unique IDs can be associated with electronically readable tags to be implanted into the companion animal, for example, by the companion animal health care provider in the companion animal health care provider's office. These unique IDs are inputted into the companion animal's profile in the companion animal database 118 after implantation. At step 204, a plurality of data related to companion animal such as companion animal profile, companion animal owner's profile and companion animal health care provider profile which are stored in the companion animal database 118, are extracted. At step 206, the unique ID in the companion animal's profile is then matched with the unique ID in the electronic record. Upon match, the data is stored in the electronic record with its corresponding unique ID at step 208. Then at step 210, a plurality of data related to the health of the companion animal is received from the companion animal database 118. Upon receipt of such data, at step 212, it is processed and at least some of the data is summarized in summary codes, such as alphanumeric codes, which are assigned to the health data. Thereafter, at step 214, the alphanumeric codes with their corresponding data are stored in their corresponding electronic records established in the central database 106. Upon storage, at step 216, remote access to at least a portion of the data related to the companion animal in the electronic records are provided to the companion animal owner 110 and/or companion animal health care provider 116.

While the above-described flow diagram comprises steps of first extracting the data related to the companion animal comprising companion animal profile, companion animal owner profile and companion animal health care provider profile, and then extracting health data of the companion animal, alternatively, all this data may preferably be extracted simultaneously.

Also, in one of the preferred embodiments, the data related to the companion animal provided from the health care provider center 116 can alternatively be manually inputted into the central database 106 of the service center 102. This manual inputting may preferably occur due to the fact that there is no companion animal database 118 in the center 116. In another preferred embodiment, the owner 110 can preferably provide all the data related to the companion animal directly to the service center 102 to be uploaded into the database 106.

A portion of the data can include health data with corresponding alphanumeric codes, companion animal profiles, companion animal owner profiles and the companion animal health care provider profiles. Note that, in some embodiments, the companion animal owner 110 may be authorized to edit data related to companion animal profile and the companion animal owner profile, but otherwise be restricted in his/her ability to alter the data. The companion animal owner 110 can send a request via the companion animal center 102 to edit data on the companion animal profile and/or companion animal owner profile. Such data will be updated in the electronic record in the database 106.

The companion animal service center 102 provides various services to companion animal owners registered with the service, which may be on a for-fee basis, such as an annual fee, and/or monthly, or other basis. These services can include customized e-mails, safe and speedy animal recovery, on-line companion animal health information, companion animal id, companion animal emergency center, municipal licensing, discounts to companion animal related products/services and marketing to the unregistered companion animal owners. These services are described in greater detail herein below.

Customized e-mails can provide comprehensive information and tips regarding the companion animal such as companion animal's “milestones”, companion animal care tips, useful accessories, companion animal owner's data and more. The customized e-mails may also provide reminders for scheduled companion animal health care provider appointments, medicine dosage, prescription refills, etc. These reminders are requested by the companion animal owner 110 to the service center 102. The request is processed by the processor 104 in the service center 102 based upon the electronic record of the companion animal in the central database 106 which is extracted and updated from the companion animal database 118 in the center 116 as discussed above.

In conjunction with pet recovery services, access to a companion animal's health data allows animal health care providers 112 such as shelters, vets, animal hospitals etc., to appropriately treat found companion animals. As part of the recovery services, upon receipt of notification from the companion animal owner 110 that the companion animal is lost including any information on companion animal's disappearance, the center 102 notifies all the participating health care providers within a specific distance. A server 109 at center 102 may notify via various communication means such an e-mail, phone, fax, page etc. The notification will preferably include companion animal's disappearance and a portion of the companion animal's profile including companion animal's photo that may be critical to assist in the identification of the companion animal. The portion of the companion animal's profile is extracted from the electronic record of the database 106. The center 102 may preferably forward the photo and the critical data to the registered companion animal owners listed in the database 106 residing within a certain distance from the location where the companion animal was lost. The center 102 may optionally create a printable poster of the companion animal including the companion animal's photo and the companion animal profile and forward the same to the companion animal owner 110 electronically, for printing by the owner in his/her home or by printing by the center 102 through electronic exchange of media, for posting in the area where the companion animal was lost. Again, the photo and the companion animal owner profile is extracted from the electronic record of the companion animal in the central database 106. Desirably, if a companion animal is found by the animal health care provider 112 such as a shelter or vet, the companion animal is scanned by a microprocessor-controlled device 114 in the provider 112 location to read the unique ID to identify the companion animal. The Companion animal service center 102 receive a communication from the animal health care provider 112 regarding the found companion animal with the unique ID. The processor 104 in the center 102 will match the unique ID with the electronic records in the database 106 to obtain the contact information of the companion animal owner profile of the found companion animal and the companion animal owner 110 will be notified. The companion animal owner 110 may be notified via various communication means such as e-mail, phone, fax, pager, etc. as preferably set up by the owner in the companion owner's profile. If required, the center 102 will also be able to retrieve the health data on the companion animal from the central database 106 and forward the health data to the animal health care provider 112 to treat the companion animal with any necessary medical care.

The companion animal health data can comprise a companion animal's profile, companion animal owner's profile and companion animal's medical treatment. As discussed above, this companion animal health information is received by the center 102 from the remote companion animal database 118, located in the health care center 116 and further processed by the processor 104 and stored in the electronic records of the central database 106. The companion animal service will provide this companion animal health information online via the center 102 to the registered companion animal owner 110. The companion animal owners 110 may preferably alter or modify their companion animal's profile and the companion animal owner's profile by logging onto a server at the center 102 of the companion animal service. These modifications are received online by the center 102 and further updated and stored on to the central database 106, thereby providing current information related to the companion animal.

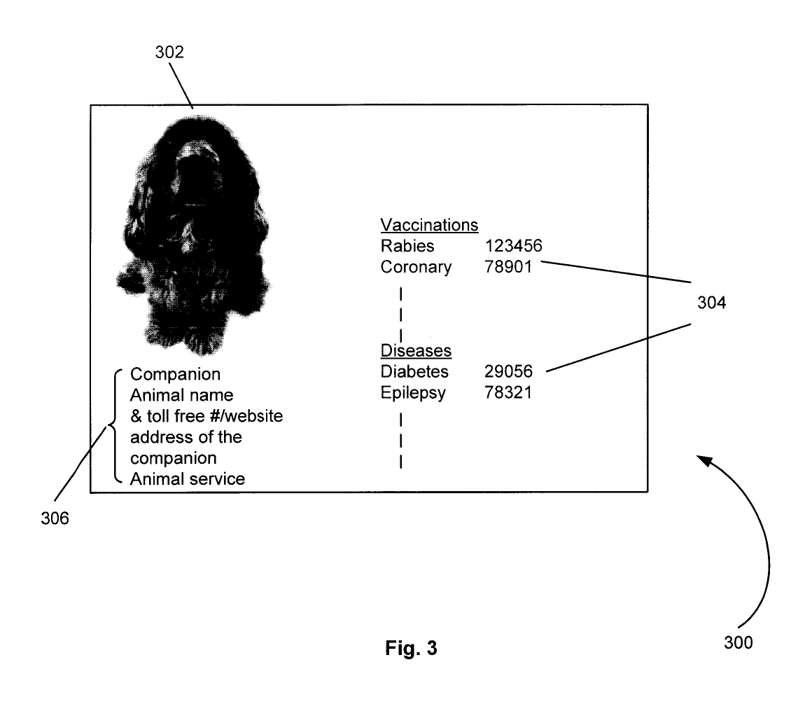

An example of a companion animal card 300, in accordance with some embodiments, is shown in FIG. 3, and is preferably a wallet-sized card which comprises a data set of pertinent information related to the companion animal. This companion animal ID card comprises a companion animal's picture (image) 302, and a portion of the health data with corresponding codes 304. The companion animal ID card may also preferably provide name and toll free telephone number 306 of the companion animal service and any additional pertinent information related to the companion animal. Note, as discussed above, the companion animal owner 110 has access online via a Web server at the center 102 to the same pertinent information as provided on the companion animal id card. The processor 104 extracts the pertinent information from the electronic record of the central database 106 and generates the companion animal ID card. In some embodiments, a printer designed for use with cards can be used. The companion animal ID card is very useful to the companion animal owner 110 when away from home with his/her companion animal and the companion animal needs to be treated by the animal health care provider 112 other than the companion animal's health care provider. The companion animal owner 110 can show the companion animal id card to the animal health care provider 112 which will gives the health data needed to treat the companion animal. Alternatively, the companion animal owner 110 can access the Internet and obtain the same pertinent health data provided on the companion animal id. Upon treatment of the companion animal, the companion animal owner 110 is provided with a document by the animal health care provider 112 including the details of the treatment. This document is submitted by the companion animal owner 110 to the companion animal service center 102 which in turn updates the health records in the electronic record for the companion animal in the central database 106. It is important to note that the health data is only updated upon receipt of the official document from the authorized health care provider. Optionally, if the companion animal health care provider treating the companion animal is also a vet's clinic or health care center 116, then the companion animal's health data will preferably be automatically updated in the electronic record of the central database 106.

In another aspect of the system, companion animal emergency care service with 24-hour access is provided by an on-call companion animal health care provider such as a veterinarian who provides emergency treatment advice and referral to the local emergency clinic. Thus, in case of a companion animal emergency, the companion animal owner 110 will communicate with the emergency center 108 of the companion animal service center 102. The emergency center 108 will in turn put the companion animal owner 110 in touch with an on-call veterinarian. The emergency center 108 can also preferably retrieve the health data related to the companion animal from the electronic record of the central database 106 and provide the data to the on-call veterinarian, and if needed to the local emergency clinic. The emergency care service thus provides the 24-hour care to treat the companion animal.

Another service provided by the companion animal service to the companion animal owners 110 is a facilitated method of obtaining a municipal license for their companion animals. A municipal license typically is a municipality-required registration, typically requiring annual renewal, for a companion animal that requires providing public health information on rabies vaccination history, spaying record and more to the municipality. Upon request from the companion animal owner 110, a server 109 at center 102 will automatically fill out a licensing application form by extracting required data from the electronic record in the central database 106 for that companion animal. This automatic filling out of the form may preferably be performed by the processor 104. Optionally, a user can manually fill out the form by retrieving data from the electronic record in the central database 106 for that companion animal. The server 109 at center 102 will initially verify with the companion animal database 118 in the center 116 to confirm that the data is updated prior to extracting from the central database 106. Companion animal service then submits the licensing application form and other information to the municipality for approval. Furthermore, based on the license date in the companion animal's profile data, the Companion animal service will also automatically renew the license each year and further communicate with the companion animal owners 110 regarding the license renewal. This automated municipal licensing saves time and hassle for the companion animal owners and ensures that the companion animal owners are in compliance with the law. Alternatively, companion animal service can provide the companion animal owner 110 with the licensing application form with instructions to fill out the form so the companion animal owners can preferably obtain the municipal license on their own. In some embodiments, a completed form, populated with information about the owner and companion animal, can be generated.

Discounts on companion animal related products/services offerings may be provided by the companion animal service to the companion animal owners 110 based on the companion animal profile and health data stored in the electronic record of the central database 106. The companion animal service center 102 may provide discounts/coupons on products based on the companion animal's profile and health data retrieved from the database 106 and additionally provide link to various online services to purchase these products. The companion animal service center 102 may also desirably retrieve companion animal owner's contact information (address) from the companion animal owner's profile in the central database 106. The server 109 at center 102 will use this information to provide coupons on stores (carrying companion animal related products) near the address of the companion animal owner 110.

The companion animal owners described throughout the present application are the owners registered or enrolled with the companion animal health care service. However, there may be one or more companion animal health care owners not enrolled in the companion animal service. The contact information of these unregistered companion animal owners are retrieved from the companion animal owner's profile in the electronic record of the central database 106. Using this contact information, these unregistered companion animal owners are provided with information and incentives to enroll in the companion animal service.

Note that although the present invention described herein is referred to as companion animal, it can be preferably be any animal or even a human being.

In accordance with certain embodiments, any device described herein as a server can be a computer, or any computing device capable of performing the services as described above. Processors, as used herein, are any devices or parts of computers (i.e., central processing units) capable of interpreting and executing computer programs, as is known to those of skill in the art. As used herein, the terms central database, database, and/or companion animal database can comprise of preferably one more databases or any other storage medium that electronically or otherwise stores data, as is known to those of skill in the art.

While the present invention has been described and illustrated in connection with the above embodiments, many variations and modifications, as will be evident in those skilled in the art, may be made without departing from the spirit and scope of the present invention. The embodiments of the present invention are thus not to be limited to the precise details of methodology or construction set forth above, as such variations and modifications are intended to be included within the scope of the present invention.

1. A method for storing and providing information related to a companion animal, the method comprising the steps of:
a. establishing an electronic record for a companion animal in a database maintained remotely from a location of a health care provider to the companion animal;
b. associating the electronic record with a unique identifier that is readably encoded in an electronic tag that is implanted in the companion animal, said unique identifier identifying the companion animal in the central database;
c. receiving electronically from the companion animal's health care provider a plurality of data related to health of the companion animal;
d. assigning alphanumeric codes to one or more of the health data;
e. storing the alphanumeric codes and the health data in the electronic record; and
f. providing the companion animal's owner with remote access via the Internet to at least a portion of the electronic record.

2. The method of claim 1 wherein the health data comprise vaccination and health treatment data.

3. The method of claim 1 wherein the electronic record comprises a companion animal profile, a companion animal owner profile, and a companion animal health care provider profile.

4. The method of claim 3 wherein the companion animal profile includes data related to the companion animal comprising one or more of name, id number, gender, weight, breed, color, and birth date.

5. The method of claim 3 wherein the companion animal owner profile comprises a companion animal owner name, owner contact information and owner billing information.

6. The method of claim 3 wherein the companion animal health care provider profile comprises a companion animal health care provider name and companion animal health care provider contact information.

7. The method of claim 3 further comprising receiving from the companion animal owner modified data related to the companion animal profile and altering the companion animal profile to incorporate the modified animal profile data.

8. The method of claim 3 further comprising receiving from the companion animal owner modified data related to the companion animal owner profile and altering the companion animal owner profile to incorporate the modified animal owner profile data.

9. The method of claim 3 further comprising receiving from the companion animal health care provider a modified data related to the companion animal health care provider profile and altering the companion animal health care provider profile to incorporate the modified health care provider data.

10. The method of claim 1 further comprising generating a companion animal data set comprising at least a portion of the electronic record.

11. The method of claim 1 further comprising providing at least a portion of the health data to the companion animal's health care provider in response to an inquiry.

12. The method of claim 1 further comprising providing at least a portion of the health data to the companion animal's owner in response to an inquiry.

13. The method of claim 1 further comprising periodically updating the health data in the database.

14. The method of claim 1 wherein the electronic tag is an RFID tag.

15. A method for providing information related to a companion animal, the method comprising the steps of:
a. receiving a communication regarding a companion animal unique identifier that is readably encoded in an electronic tag that is implanted in the companion animal;
b. accessing an electronic record in a database associated with the unique identifier, record comprising a plurality of data related to the health of the companion animal; and
c. providing at least a portion of the electronic record to an animal health care provider in response to the communication.

16. The method of claim 15 wherein the health data comprise vaccination and health treatment data.

17. The method of claim 15 wherein the electronic tag is an RFID tag.

18. The method of claim 15 wherein the electronic record comprises a companion animal profile and a companion owner profile.

19. The method of claim 18 wherein the companion animal profile comprises a companion animal owner name, owner contact information and owner billing information.

20. The method of claim 19 further comprising the step of using the owner contact information to communicate with the companion animal owner regarding the companion animal.

21. The method of claim 18, wherein the companion animal profile includes an image of the companion animal, the method further comprising the step of generating a poster of the companion animal incorporating at least a portion of the image.

22. A method for providing information related to a companion animal, the method comprising the steps of:
a. receiving a request from a companion animal owner regarding licensing a companion animal;
b. retrieving an electronic record in a database associated with the companion animal, said electronic record comprising a plurality of data related to health of the companion animal; and
c. communicating at least a portion of the health data of the companion animal to a municipal licensing system in an network environment.

23. The method of claim 22 further comprising the step of providing the companion animal owner with access over the Internet to at least portion of the health data.

24. The method of claim 23 further comprising the step of providing, via a web interface, a municipal license application form to be completed by the animal companion owner.

25. The method of claim 22 further comprising the step of generating a municipal animal license application form populated with the at least portion of the health data of the companion animal.

26. A method for providing information related to a companion animal owner, the method comprising the steps of:
a. retrieving an electronic record in a database associated with a companion animal, the electronic record comprising a plurality of data related to health of the companion animal and data related to contact information of an owner of the companion animal; and
b. providing marketing services to the companion animal owner based on the electronic record associated with the companion animal.

27. The method of claim 26 wherein the marketing services comprise providing products or services information related to the health data of the companion animal.

28. The method of claim 26 wherein the database comprises data associated with companion animal owners enrolled to receive a service and data associated with companion animal owners not enrolled to receive the service.

29. The method of claim 28 wherein the marketing services comprises providing the unenrolled companion animal owners with information related to enrolling with the service.

30. A method for storing and providing information related to a companion animal, the method comprising the steps of:

31. A method for storing and providing information related to a companion animal, the method comprising the steps of:
a. establishing an electronic record for a companion animal in a database maintained remotely from a location of a health care provider to the companion animal;
b. associating the electronic record with a unique identifier that corresponds to a biometric code related to the companion animal, said unique identifier identifying the companion animal in the central database;
c. receiving electronically from the companion animal's health care provider a plurality of data related to health of the companion animal;
d. assigning alphanumeric codes to one or more of the health data;
e. storing the alphanumeric codes and the health data in the electronic record; and
f. providing the companion animal's owner with remote access via the Internet to at least a portion of the electronic record.

32. The method of claim 31 wherein said biometric code is related to one or more of biometrics comprising an iris scan, retina scan, fingerprints, hand geometry, facial patterns, voice.
